(19) United States
(12) Patent Application Publication
(10) Pub. No.: US 2010/0197161 A1
(43) Pub. Date: Aug. 5, 2010

(54) POWER OUTLET

(75) Inventor: Wayne William Dennes, New South Wales (AU)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/598,262

(22) PCT Filed: Apr. 2, 2008
(86) PCT No.: PCT/AU08/00470

§ 371 Date: Apr. 1, 2010

(30) Foreign Application Priority Data
May 4, 2007 (AU) 2007902395

(51) Int. Cl. H01R 4/24

(52) U.S. Cl. 439/404

(57) ABSTRACT

A power outlet for effecting an electrical connection between an electric device and insulated conductors of an electric power cable, including a socket having apertures including electrically conductive socket contacts seated therein for effecting electrical connection to corresponding electrically conductive contacts of a plug of the electric device; a plurality of primary channels shaped to at least partially receive, and seat therein, respective lengthwise sections of the insulated conductors of the power cable; a plurality of insulation displacement contacts for making separate electrical connections to said insulated conductors, when received in said primary channels, under relative movement between the insulation displacement contacts and the insulated conductors; a connector, relatively movable with respect to the primary channels, for effecting said relative movement, wherein the insulation displacement contacts are electrically coupled to respective ones of said socket contacts; and said primary channels extend transversely to a lengthwise direction of extent of the power outlet.

### TECHNICAL FIELD OF THE INVENTION

The present invention relates to a power outlet.

### BACKGROUND OF THE INVENTION

Power outlets are typically used to electrically couple electric devices to the insulated conductors of a power cable. They have previously employed screw contacts to effect electrical connections to the insulated conductors of the power cable. The following steps may be performed to electrically connect a power outlet to the insulated conductors of a power cable:
1. Stripping of insulation from end sections of the conductors;
2. Inserting stripped end sections of the conductors into openings of respective connectors of the power outlet; and
3. Fastening the conductors to the connectors by tightening the screws.

Performing the above-described steps to install a power outlet may be labour intensive and inconvenient.

An electrical connection may otherwise be effected using an insulation displacement contact that includes a contact element which is bifurcated so as to define two opposed contact portions separated by a slot into which an insulated conductor may be pressed so that edges of the contact portions engage and displace the insulation and such that the contact portions resiliently engage and make electrical connection with the conductor of the wire. Such a contact is described in, for example U.S. Pat. Nos. 4,452,502 and 4,405,187. While, in some cases, making electrical connection to a single wire in the above way is all that is necessary, occasions arise where it would be useful to make connection to more than one wire by inserting the wires, one after the other, into the slot. With a carefully designed contact it may be possible to make connections in this way to two wires, but it is difficult to make effective connections to several wires. This arises because, during the process of introducing a first wire into the slot, the contact portions are resiliently deformed, such that the gap between them is to some extent increased. The resultant increase in slot width may still permit an adequate connection to be made to a second wire when inserted into the slot. However, the increased slot width may even be such that the contact portions fail to properly pierce the insulation, or it may otherwise leave the second wire unreliably gripped. This problem becomes worse as more wires are inserted.

The above problem is alleviated in Krone LSA-PLUS connectors by arranging that the contact portions are torsionally twisted during insertion of the wires. That is, the wires are introduced into the slot with their directions of extent arranged at an angle of about 45 degrees to the side to side direction of the slot, so that insertion of the wires tends to deflect contacting edges of the respective contact portions outwardly away from each other, in opposite directions relative to the general plane of the contact. In that case, it is possible to achieve good connection to two wires but even in this construction more than two wires may not be adequately accommodated. U.S. Pat. No. 5,492,484 also describes a particular form of contact that is indicated as being able to terminate more than a single conductor. This is however complicated in form.

It is generally desirable to provide a power outlet that can effect quick and easy electrical connection to the insulated conductors of a power cable.

It is generally desirable to overcome or ameliorate one or more of the above mentioned difficulties, or at least provide a useful alternative.

### SUMMARY OF THE INVENTION

In accordance with the present invention, there is provided a power outlet for effecting an electrical connection between an electric device and insulated conductors of an electric power cable including:
(a) a socket having apertures including electrically conductive socket contacts seated therein for effecting electrical connection to corresponding electrically conductive contacts of a plug of the electric device;
(b) a plurality of primary channels shaped to at least partially receive, and seat therein, respective lengthwise sections of the insulated conductors of the power cable;
(c) a plurality of insulation displacement contacts for making separate electrical connections to said insulated conductors, when received in said primary channels, under relative movement between the insulation displacement contacts and the insulated conductors;
(d) a connector, relatively movable with respect to the primary channels, for effecting said relative movement,
   wherein the insulation displacement contacts are electrically coupled to respective ones of said socket contacts, and said primary channels extend transversely to a lengthwise direction of extent of the power outlet.

Advantageously, the above described power outlet can effect quick and easy electrical connection to the insulated conductors of a power cable.

### BRIEF DESCRIPTION OF THE DRAWINGS

Preferred embodiments of the present invention are hereafter described, by way of non-limiting example only, with reference to the accompanying drawing in which:

FIG. 1 is a diagrammatic illustration of a front view of a power outlet;

FIG. 2 is a diagrammatic illustration of a top view of the power outlet shown in FIG. 1;

FIG. 3 is a diagrammatic illustration of a bottom view of the power outlet shown in FIG. 1;

FIG. 4 is a diagrammatic illustration of a side view of the power outlet shown in FIG. 1;

FIG. 5 is a diagrammatic illustration of a back view of the power outlet shown in FIG. 1;

FIG. 6 is a diagrammatic illustration of a back view of the power outlet shown in FIG. 1 coupled to insulated conductors of power cables;

FIG. 7 is a diagrammatic illustration of a perspective view of the power outlet shown in FIG. 6;

FIG. 8 is a diagrammatic illustration of a side view of the power outlet shown in FIG. 6;

FIG. 9 is a diagrammatic illustration of a perspective view of the power outlet shown in FIG. 6 arranged in another condition of use;

FIG. 10 is a diagrammatic illustration of a back view of the power outlet shown in FIG. 6 arranged in yet another condition of use;

FIG. 11 is a diagrammatic illustration of a side view of the power outlet shown in FIG. 10;

FIG. 12 is a diagrammatic illustration of a connector of the power outlet shown in FIG. 1;

FIG. 13 is a diagrammatic illustration of a perspective view of electrically conductive contacts of the power outlet shown in FIG. 1;

FIG. 14 is a diagrammatic illustration of another perspective view of the electrically conductive contacts shown in FIG. 13;

FIG. 15 is a diagrammatic illustration of a back view of the electrically conductive contacts shown in FIG. 13;

FIG. 16 is a diagrammatic illustration of an exploded view of the electrically conductive contacts shown in FIG. 13; and

FIG. 17 is a diagrammatic illustration of another exploded view of the electrically conductive contacts shown in FIG. 13.

### DETAILED DESCRIPTION OF PREFERRED EMBODIMENTS OF THE INVENTION

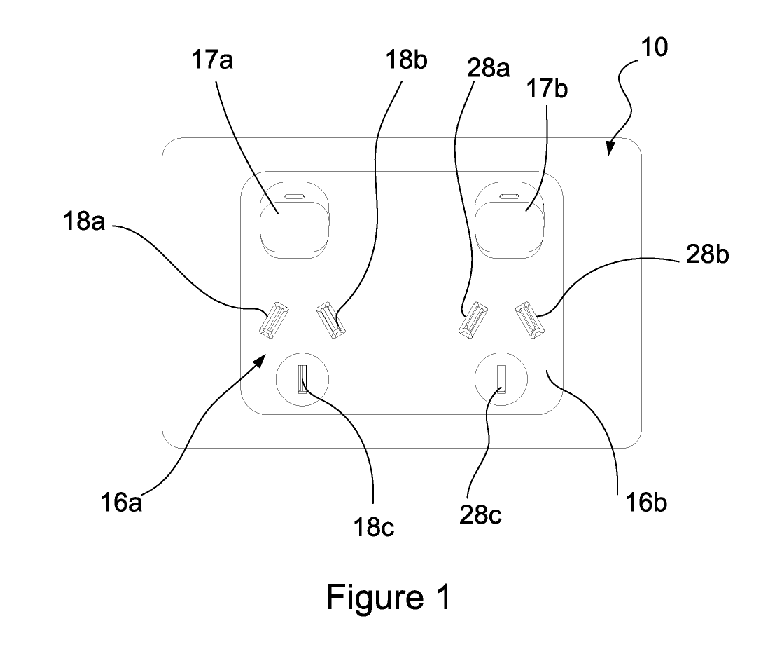

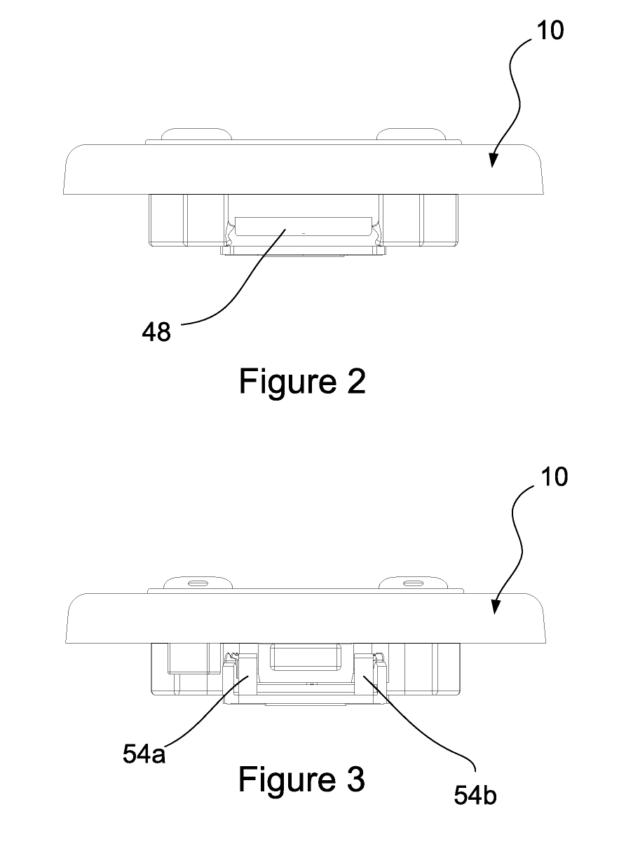

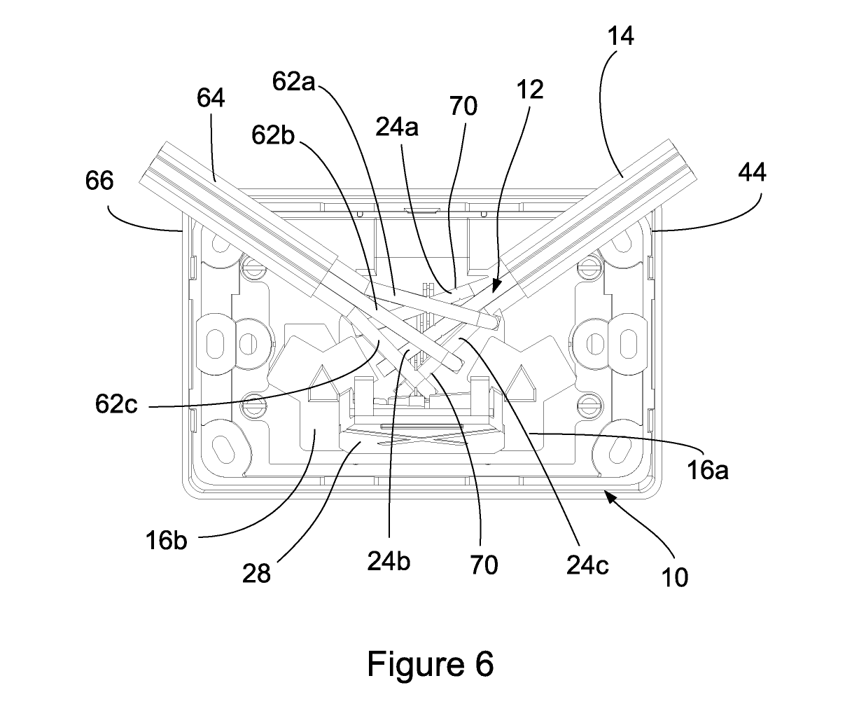

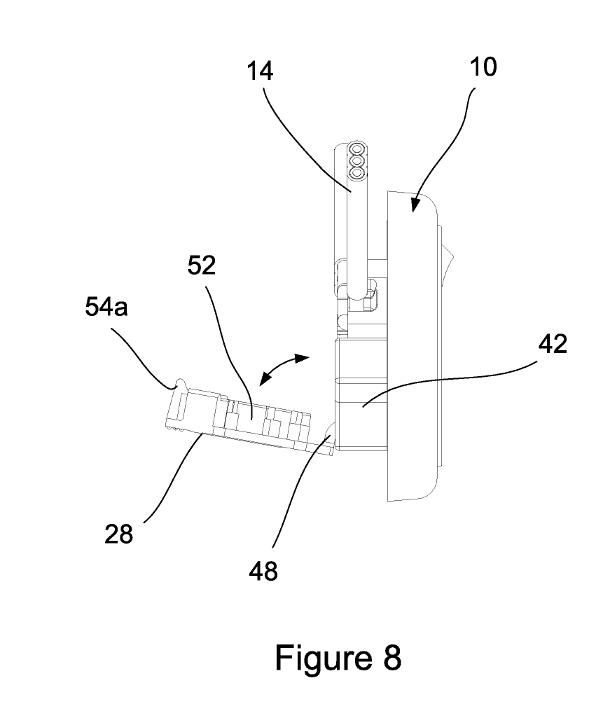

The power outlet 10 shown in FIGS. 1 to 5 is used to effect electrical connection between an electric device (not shown) and the insulated conductors 12 of an electric power cable 14 in the manner shown in FIGS. 6 to 11. The power outlet 10 can, advantageously, effect electrical connections with the insulated conductors 12 of the power cable 14 without the need for an installer to screw the conductors into position. The power outlet 10 can, advantageously, be utilised to effect connection to the insulated conductors 12 of the power cable 14 quickly and easily.

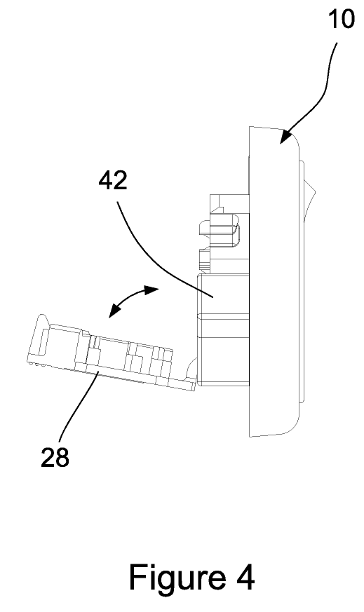

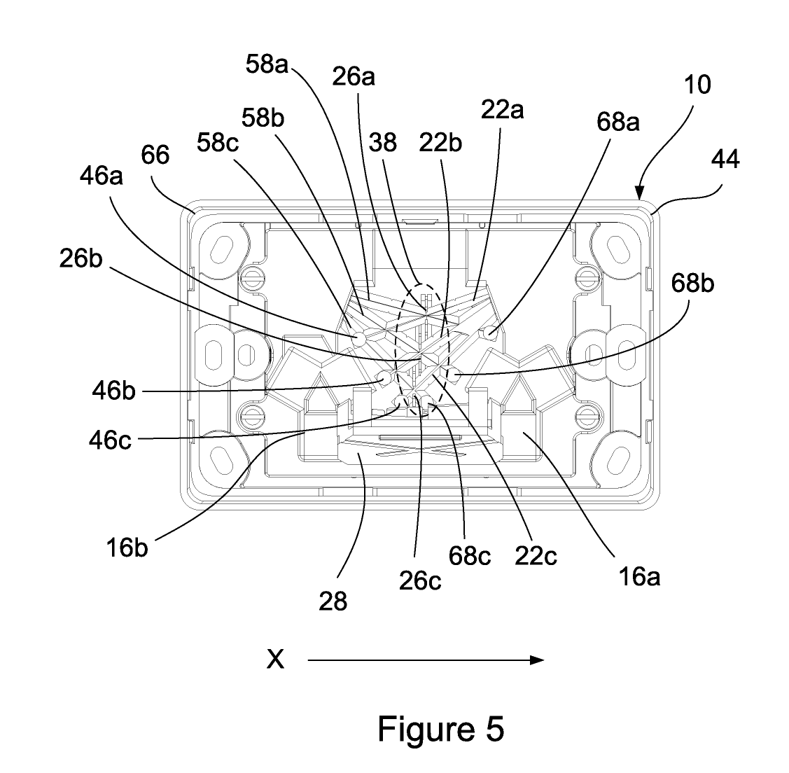

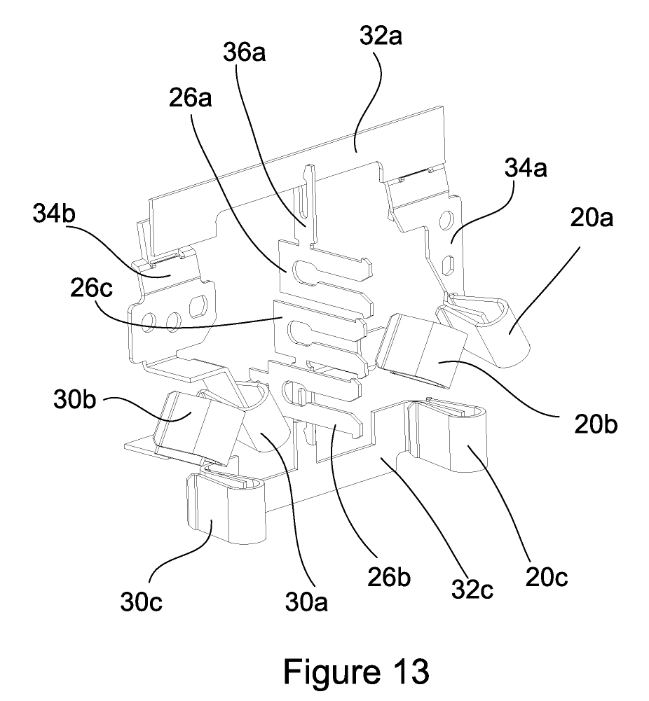

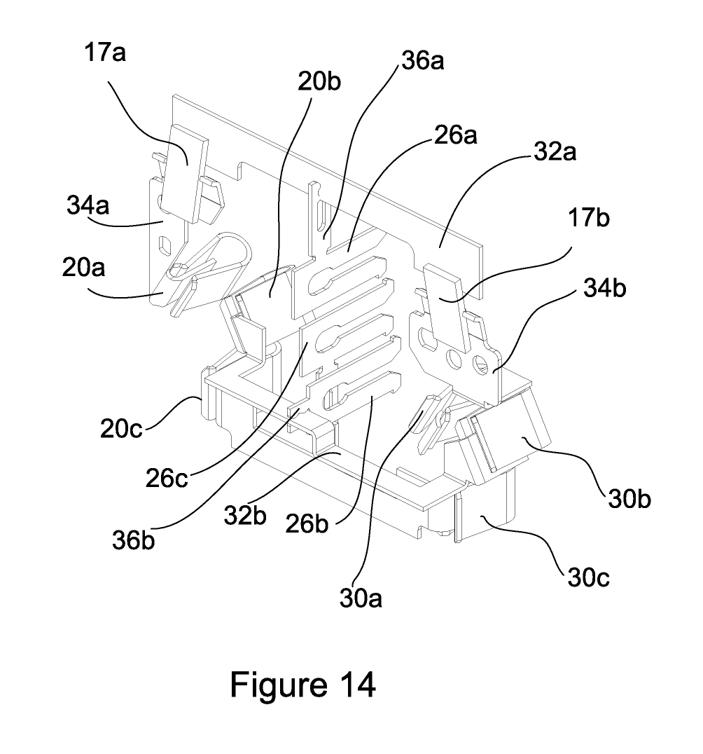

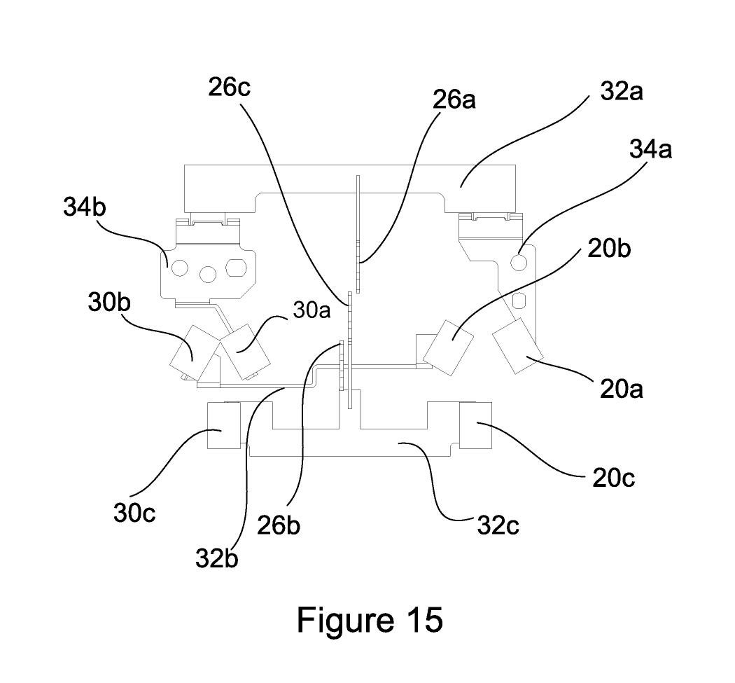

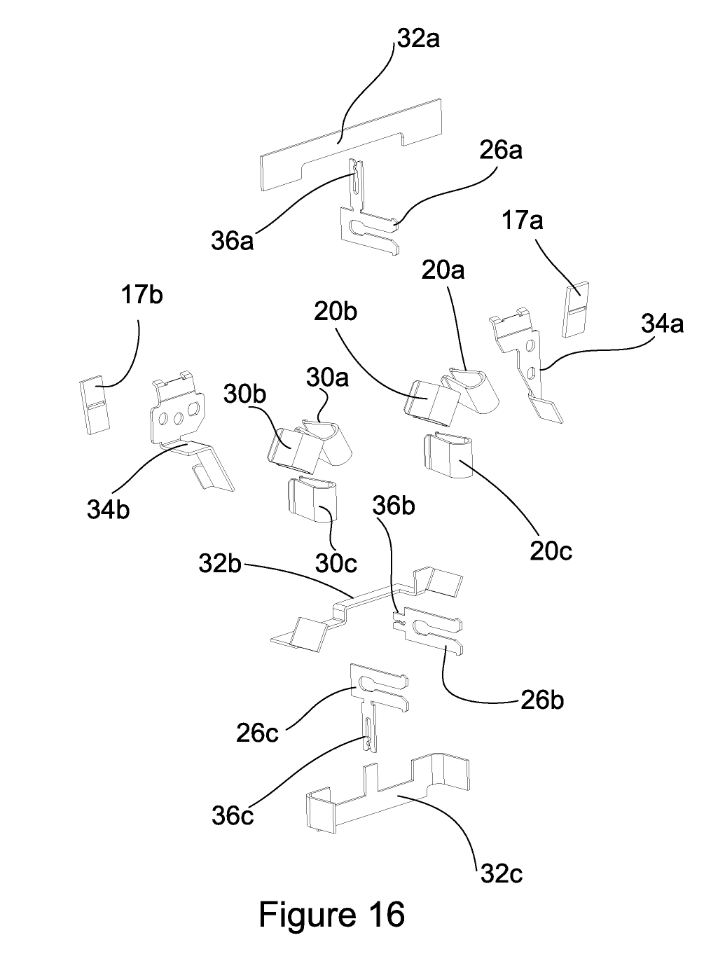

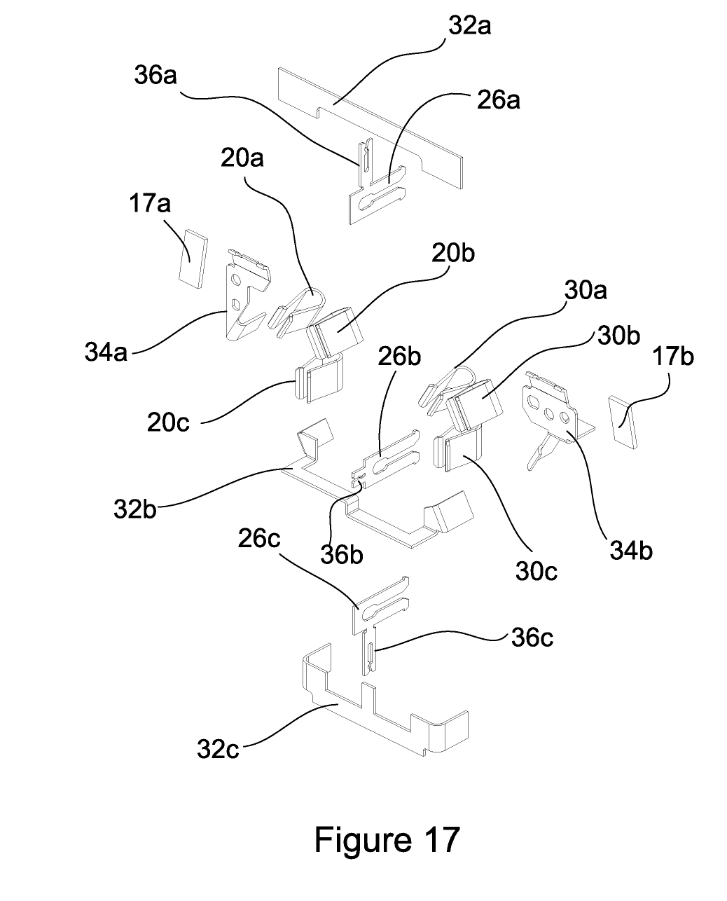

The outlet 10 includes a socket 16a having apertures 18a, 18b, 18c including electrically conductive socket contacts 20a, 20b, 20c, seated therein, arranged in the manner shown in FIGS. 13 to 17. The socket contacts 20a, 20b, 20c are shaped to receive, and form electrical connections with, corresponding electrically conductive contacts of the plug (not shown) of the electric device. As particularly shown in FIG. 5, the outlet 10 includes primary channels 22a, 22b, 22c shaped to at least partially receive, and seat therein, respective lengthwise sections 24a, 24b, 24c of the insulated conductors 12 of the power cable 14. The outlet 10 includes a plurality of insulation displacement contacts 26a, 26b, 26c for making separate electrical connections to the insulated conductors 12, when received in the primary channels 22a, 22b, 22c, under relative movement between the insulation displacement contacts 26a, 26b, 26c and the insulated conductors 12. As particularly shown in FIG. 4, the outlet 10 also includes a connector 28, relatively movable with respect to the primary channels 22a, 22b, 22c, for effecting the relative movement between the insulation displacement contacts 26a, 26b, 26c and the insulated conductors 12. The insulation displacement contacts 26a, 26b, 26c are electrically coupled to respective ones of the socket contacts 20a, 20b, 20c. The primary channels 22a, 22b, 22c extend transversely to a lengthwise direction of extent “X” of the power outlet 10.

The outlet 10 also includes another socket 16b having apertures 28a, 28b, 28c including electrically conductive socket contacts 30a, 30b, 30c, seated therein, arranged in the manner shown in FIGS. 13 to 17. The socket contacts 30a, 30b, 30c are shaped to receive, and form electrical connections with, corresponding electrically conductive contacts of a plug (not shown) of another electric device connected to the socket 16b. The insulation displacement contacts 26a, 26b, 26c are electrically coupled to respective ones of the socket contacts 30a, 30b, 30c.

As particularly shown in FIGS. 13 to 17, the socket contacts 20a and 30a of the sockets 16a and 16b are shaped for electrical connection to corresponding active electrical contacts of a plug of an electrical device (not shown). The socket contacts 20a and 30a are electrically coupled to an electrically conductive spanning contact 32a by electrically conductive clips 34a and 34b. The insulation displacement contact 26a includes a lateral bifurcated contact 36a electrically coupled to the spanning contact 32a. The spanning contact 32a is electrically connected to the insulation displacement contact 26a when inserted between the bifurcated arms of the contact 36a. The bifurcated arms of the contact 36a resiliently bear against the spanning contact 32a and thereby secure the contacts 32a, 36a in electrical communication.

The active socket contacts 20a, 30a can be independently electrically isolated from the corresponding insulation displacement contact 26a by corresponding switches 17a, 17b. The switches operate in a conventional manner and are not described here in further detail.

The socket contacts 20b and 30b of the sockets 16a and 16b are shaped for electrical connection to corresponding neutral electrical contacts of a plug of an electrical device (not shown). The socket contacts 20b and 30b are electrically coupled to an electrically conductive spanning contact 32b. The insulation displacement contact 26b includes a longitudinal bifurcated contact 36b electrically coupled to the spanning contact 32b. The spanning contact 32b is electrically connected to the insulation displacement contact 26b when inserted between the bifurcated arms of the contact 36b. The bifurcated arms of the contact 36b resiliently bear against the spanning contact 32b and thereby secure the contacts 32b, 36b in electrical communication.

The socket contacts 20c and 30c of the sockets 16a and 16b are shaped for electrical connection to corresponding earth electrical contacts of a plug of an electrical device (not shown). The socket contacts 20c and 30c are electrically coupled to an electrically conductive spanning contact 32c. The insulation displacement contact 26c includes a lateral bifurcated contact 36c electrically coupled to the spanning contact 32c. The spanning contact 32c is electrically connected to the insulation displacement contact 26c when inserted between the bifurcated arms of the contact 36c. The bifurcated arms of the contact 36c resiliently bear against the spanning contact 32c and thereby secure the contacts 32c, 36c in electrical communication.

The insulation displacement contacts 26a, 26b, 26c are preferably electrically connected to respective spanning contacts 32a, 32b, 32c by bifurcated contacts 36a, 36b, 36. However, they could, alternatively, be electrically coupled to the spanning contacts 32a, 32b, 32c by any other suitable means.

As particularly shown in FIG. 5, the insulation displacement contacts 26a, 26b, 26c are stacked vertically, in respective primary channels 22a, 22b, 22c, in a central section 38 of the back side 40 of the outlet 10. Side to side directions of the openings of the contacts 26a, 26b, 26c are generally parallel. In other words, slots defined by the bifurcated arms of the contacts 26a, 26b, 26c open in a generally common direction “X”.

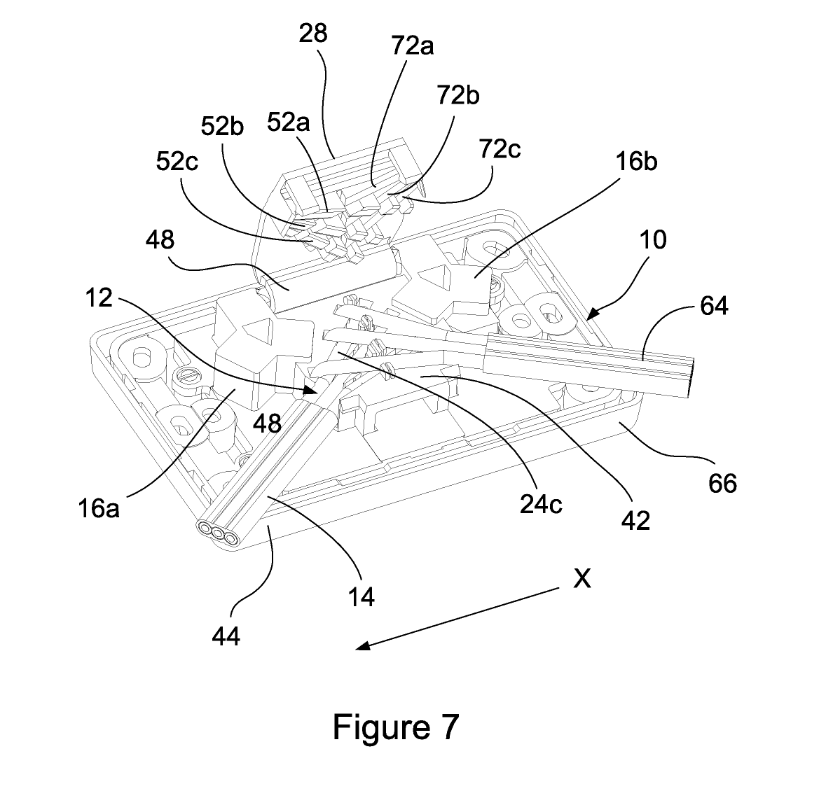

As particularly shown in FIG. 7, the primary channels 22a, 22b, 22c are formed in a channel plate 42 coupled to the back side 40 of the power outlet 10. The channel plate 42 is centrally disposed on the back side 40 of the outlet 10. The channels 26a, 26b, 26c extend through respective insulation displacement contacts 26a, 26b, 26c and converge at a common point towards the corner 44 of the back side 40 of the connector 10. Thus, the insulated conductors 24a, 24b, 24c fan out from the cable 14 when they are seated in corresponding channels 22a, 22b, 22c. The cable 14 thereby extends past the corner 44 of the back side 40 of the outlet 10 when the insulated conductors 24a, 24b, 24c are seated in their respective channels 22a, 22b, 22c. As particularly shown in FIG. 5, the channel plate 42 includes termination wells 46a, 46b, 46c located at terminal ends of the channels 24a, 24b, 24c. The termination wells 46a, 46b, 46c are shaped to receive and electrically isolate terminal ends of the insulated conductors 24a, 24b, 24c.

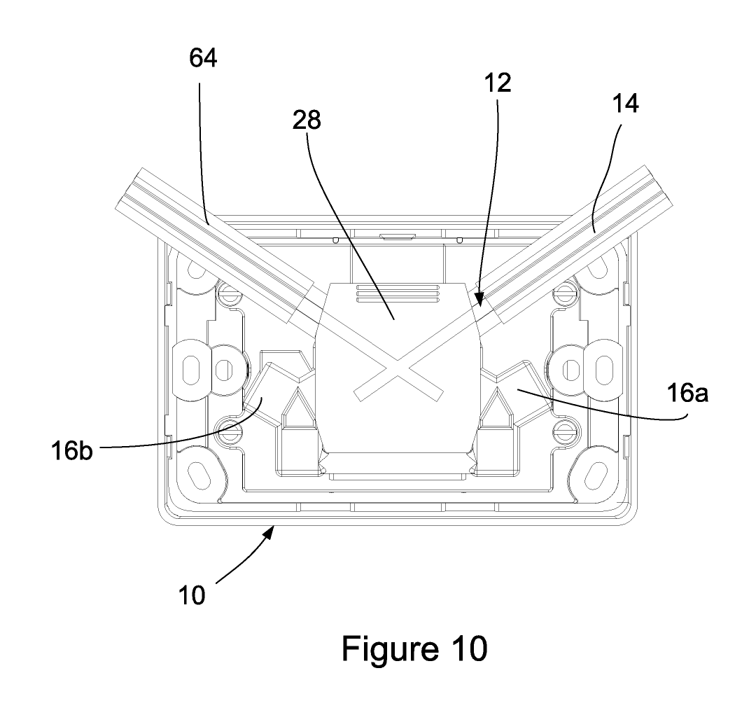

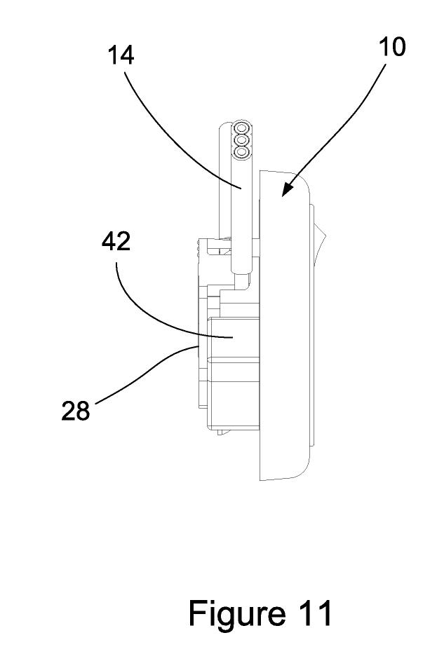

The connector 28 is formed of an electrically insulative material and has an elongate and somewhat planar shape. The connector 28 is shaped to fit over the channel plate 42 so as to close the channels 22a, 22b, 22c. A restraining means, in the form of a hinge 48, is provided to for pivotally coupling the connector 28 to the channel plate 42. The hinge 48 rotates about an axis generally parallel to, and to one side of, the lengthwise direction of extent of the outlet 10. The connector is adapted to rotate about the hinge 48 between the open position shown in FIGS. 5 to 8 and the closed position shown in FIGS. 10 and 11.

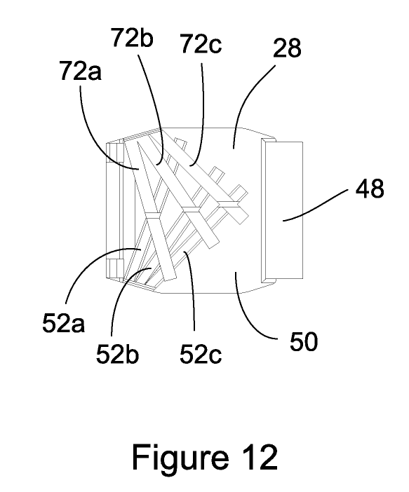

As particularly shown in FIGS. 7 and 12, an inner side 50 of the connector 28 includes a plurality of projections 52a, 52b, 52c that extend along corresponding channels 22a, 22b, 22c of the channel plate 48 when the connector 28 is arranged in the closed position. When so arranged, the projections 52a, 52b, 52c are brought to positions where they are located over, and at least partially within, respective ones of the channels 22a, 22b, 22c. When the connector 28 is moved to the closed position shown in FIG. 10, the projections 52a, 52b, 52c are likewise located in respective ones of the channels 22a, 22b, 22c.

The following steps are performed to effect electrical connection between the power outlet 10 and the insulated conductors 12 of the cable 14:
1. The outlet 10 is arranged in the open position shown in FIG. 5, where the connector 28 is swung clear of the channel plate 42;
2. The cable 14, having a portion of its outer cover removed, is laid diagonally across the back side 40 of the outlet 10;
3. The insulated conductors 24a, 24b, 24c are positioned so as to extend over respective channels 22a, 22b, 22c;
4. The insulated conductors 24a, 24b, 24c are then lightly pressed into the channels 22a, 22b, 22c;
5. The connector 28 is swung about the axis of the hinge 48 so that it overlies the channel plate 48 and so that the projections 52a, 52b, 52c engage the insulated conductors 24a, 24b, 24c and press them into their respective channels 22a, 22b, 22c; and
6. Connector 28 is then pressed fully down so that projections 52a, 52b, 52c firmly engaged the insulated conductors 24a, 24b, 24c and force them to form electrical connections with corresponding insulation displacement contacts 26a, 26b, 26c. Locking projections 54a, 54b of the connector 28 engage corresponding locking projections 56a, 56b of the back side 40 of the outlet 10. The connector 28 is thereby secured to the channel plate 42.

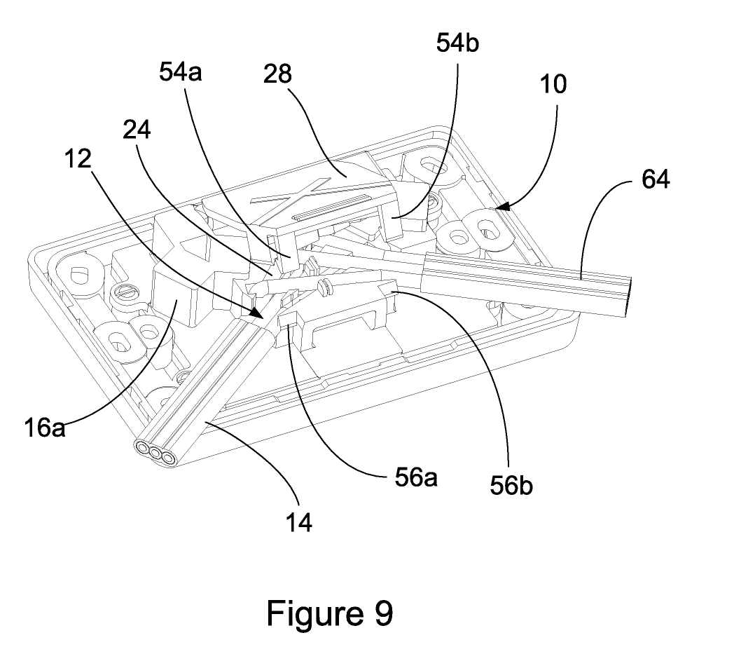

Following the above steps, the power outlet 10 need only be terminated once to provide a double socket 16a, 16b outlet. As will be observed particularly from FIG. 9, by rotating the connector 28 about the hinge 48, the projections 52a, 52b, 52c sequentially engage respective ones of the insulated conductors 24a, 24b, 24c. That is to say, at first the projection 52c is brought into contact with the wire 24c located in the channel 22c; then the projection 52b is brought in to contact with the wire 24b located in the channel 22b; and, lastly, the projection 52a is brought into contact with the wire 24a located in the channel 22a. As a result, the wires are forced into the insulation displacement contacts 26c, 26b, 26a sequentially. The forces which need to be applied to effect the making of electrical connection to the insulation displacement contacts 26c, 26b, 26a are also sequentially applied. By this, at any one time, it is sufficient to generally apply a force which would be enough to force only one wire at a time into position.

As above mentioned, the insulation displacement contacts 26a, 26b, 26c are centrally disposed. As such, the force applied to close the connector 28 can be concentrated in one spot. Advantageously, the centrally disposed insulation displacement contacts reduce the force needed to close the connector 28.

As shown in FIG. 9, the connector 28 and the channel plate 42 may be latched in the closed position by resilient clips 54a, 54b coupled to the connector 28 which releasably grip corresponding clips 56a, 56b of the channel plate 42. The connector 28 and the channel plate 42 can otherwise be fastened together using any other suitable means.

As particularly shown in FIGS. 5 and 6, the channel plate 42 includes secondary channels 58a, 58b, 58c shaped to at least partially receive, and seat therein, respective lengthwise sections 62a, 62b, 62c of the insulated conductors a second power cable 64. The channels 58a, 58b, 58c extend through respective insulation displacement contacts 26a, 26b, 26c and converge at a common point towards another corner 66 of the back side 40 of the outlet 10. Thus, the insulated conductors 62a, 62b, 62c fan out from the cable 64 when they are seated in corresponding channels 58a, 58b, 58c. The cable 64 thereby extends past the corner 66 of the back side 40 of the outlet 10 when the insulated conductors 62a, 62b, 62c are seated in their respective channels 58a, 58b, 58c. As particularly shown in FIG. 5, the channel plate 42 includes termination wells 68a, 68b, 68c located at terminal ends of the channels 58a, 58b, 58c. The termination wells 68a, 68b, 68c are shaped to receive and electrically isolate terminal ends of the insulated conductors 62a. 62b, 62c.

The conductors 62a, 62b, 62c overlie the conductors 24a, 24b, 24c when arranged in the above described manner. The insulation displacement contacts 26a, 26b, 26c are located at the intersections of corresponding primary and secondary channels 22a, 22b, 22c, 58a, 58b, 58c. Thus, each insulation displacement contact 26a, 26b, 26c is adapted to receive, and form electrical connections therewith, two insulated conductors.

The primary and secondary channels 22a, 22b, 22c, 58a, 58b, 58c include restraining flanges 70 to inhibit longitudinal movement of the insulated conductors in the channels.

As particularly shown in FIGS. 7 and 12, an inner side 50 of the connector 28 includes a plurality of projections 72a, 72b, 72c that extend along corresponding channels 58a, 58b, 58c of the channel plate 48 when the connector 28 is arranged in the closed position. When so arranged, the projections 72a, 72b, 72c are brought to positions where they are located over, and at least partially within, respective ones of the channels 58a, 58b, 58c. When the connector 28 is moved to the closed position shown in FIG. 10, the projections 72a, 72b, 72c are likewise located in respective ones of the channels 58a, 58b, 58c.

The first primary channel 22a preferably extends at an angle of substantially 145 degrees to a corresponding first secondary channel 58a. The second primary channel 22b extends at an angle of substantially 111 degrees to a corresponding second secondary channel 58b. A third primary channel 22c extends at an angle of substantially 91 degrees to a corresponding third secondary channel 58c.

The connector 28 can preferably be terminated (closed) using standard electrician's pliers. The insulated connector 28 can prevent accidental shock. The outlet preferably includes a stripping length guide. The connector 28 is adapted to over travel past the closed position to allow correct clip engagement.

While we have shown and described specific embodiments of the present invention, further modifications and improvements will occur to those skilled in the art. We desire it to be understood, therefore, that this invention is not limited to the particular forms shown and we intend in the append claims to cover all modifications that do not depart from the spirit and scope of this invention.

1. A power outlet for effecting an electrical connection between an electric device and insulated conductors of an electric power cable, comprising:
(a) a socket having apertures including electrically conductive socket contacts seated therein for effecting electrical connection to corresponding electrically conductive contacts of a plug of the electric device;
(b) a plurality of primary channels shaped to at least partially receive, and seat therein, respective lengthwise sections of the insulated conductors of the power cable;
(c) a plurality of insulation displacement contacts for making separate electrical connections to said insulated conductors, when received in said primary channels, under relative movement between the insulation displacement contacts and the insulated conductors;
(d) a connector, relatively movable with respect to the primary channels, for effecting said relative movement,
wherein the insulation displacement contacts are electrically coupled to respective ones of said socket contacts; and said primary channels extend transversely to a lengthwise direction of extent of the power outlet.

2. The power outlet claimed in claim 1, wherein longitudinal directions of extent of the primary channels converge at a common point.

3. The power outlet claimed in claim 1, wherein the insulation displacement contacts are arranged centrally on a side of the outlet.

4. The power outlet claimed in claim 3, wherein the insulation displacement contacts are arranged side by side.

5. The power outlet claimed in claim 4, wherein side to side directions of slots of the insulation displacement contacts are parallel.

6. The power outlet claimed in claim 1, wherein each slot of the insulation displacement contacts opens in a direction substantially 45 degrees to a direction of extent of its respective channel.

7. The power outlet claimed in claim 1, including a hinge for effecting said relative movement as the connector rotates there about towards the primary channels.

8. The power outlet claimed in claim 7, wherein the connector is adapted to rotate about the hinge between an open position and a closed position.

9. The power outlet claimed in claim 8, wherein said relative movement is effected as the connector moves towards the closed position.

10. The power outlet claimed in claim 8, wherein the connector generally parallel to the primary channels when arranged in the closed position.

11. The power outlet claimed in claim 10, wherein the connector is adapted to rotate about the hinge past the closed position to force insulated conductors into the insulation displacement contacts.

12. The power outlet claimed in claim 1, including a plurality of secondary channels shaped to at least partially receive, cable, wherein the insulation displacement contacts are located at intersections of the second channels and corresponding primary channels so as to electrically connect insulated conductors seated in the primary channel with corresponding insulated conductors seated in the secondary channels during said relative movement.

13. The power outlet claimed in claim 12, wherein the secondary channels extend transversely to a lengthwise direction of extent of the power outlet.

14. The power outlet claimed in claim 12, wherein longitudinal directions of extent of the secondary channels converge at another common point.

15. The power outlet claimed in claim 12, wherein a first channel of the primary channels extends at an angle of substantially 145 degrees to a corresponding first channel of the secondary channels.

16. The power outlet claimed in claim 12, wherein a second channel of the primary channels extends at an angle of substantially 111 degrees to a corresponding second channel of the secondary channels.

17. The power outlet claimed in claim 12, wherein a third channel of the primary channels extends at an angle of substantially 91 degrees to a corresponding third channel of the secondary channels.

18. The power outlet claimed in claim 1, wherein the primary channels include one or more strain relief ribs.

19. The power outlet claimed in claim 1, wherein the secondary channels include one or more strain relief ribs.

20. The power outlet claimed in claim 1, wherein the primary channels each include a include termination well for receiving, and electrically isolating, a terminal end of an insulated conductor.

21. The power outlet claimed in claim 1, wherein the secondary channels each include a include terminal well for receiving, and electrically isolating, a terminal end of an insulated conductor.

22. The power outlet claimed in claim 1, including a cable stripping length guide.

23. The power outlet claimed in claim 1, wherein one or more of said insulation displacement contacts are electrically coupled to said corresponding socket contacts by bifurcated electrically conductive contacts.

24. The power outlet claimed in claim 1, including another socket having apertures including electrically conductive socket contacts seated therein for effecting electrical connection to corresponding electrically conductive contacts of a plug of an electric device.

25. The power outlet claimed in claim 23, wherein the socket contacts of the socket are electrically coupled to corresponding socket contacts of said another socket.

26. (canceled)
